(19) United States
(12) Patent Application Publication
(10) Pub. No.: US 2006/0232061 A1
(43) Pub. Date: Oct. 19, 2006

(54) Clamp device

(76) Inventor: Yasushi Fujiwara, Tokyo (JP)

Correspondence Address: ARENT FOX PLLC, 1050 CONNECTICUT AVENUE, N.W., SUITE 400, WASHINGTON, DC, 20036, US

(21) Appl. No.: 11/106,730

(22) Filed: Apr. 15, 2005

(51) Int. Cl. F16L 41/00

(52) U.S. Cl. 285/132.1; 285/125.1; 285/189

(57) ABSTRACT

A clamp device comprising a clamp body 1B in which main part 10A of the branch product 10 is inserted and formed with notch part 1C1 where the branch part can pass through in axial direction, wherein: a first end part 1D of the clamp body 1B presses an end part of delivery pipe 30 and a second end part 1E of the clamp device presses a step part at body 10C of the injector 10, in order for the clamp device to have an elastic force in axial direction. The clamp device can absorb the size error of the fitting part, and fit and fix the injector 10 to cylinder head 20.

### BACKGROUND OF THE INVENTION

1. Field of the Invention

The present invention relates to a clamp device holding a fitting part. More particularly, the invention relates to a branch product which forks into two, e.g. a clamp device which fits a injector to a combustion engine.

2. Description of the Related Art

The related art of the present invention comprises the injector for combustion engine as shown in FIG. 11. FIG. 11 is a sectional view of injector 100 fitted to the cylinder head 131 and fixed by clamp 105.

This injector 100 fits to delivery pipe 130 shown at the top of FIG. 11 by O-ring 120 and holding part 125 which fits the O-ring 120. And a small flange 100D of injector 100 is attached and connected to an end part of delivery pipe 130.

At the bottom side of the injector 100, body 100E is set, which fits to a fitting hole of the cylinder head 131. Further, at the upper side of the body 10E, a flange part 100B and a main part 100F are formed where clamp 105 are fitted.

At the upper part of main part 100F in the injector 100, a branch tube 100A where an electric connector is equipped to connect to a solenoid coil. Injector 100 composed as above has flange part 100B and main part 100F, accordingly, the injector 100 has a problem that the length in the axial direction becomes too long.

Plunger 100C is set at the bottom tip of the injector 100.

Two clamps 105 that fix injector 100 to cylinder head 131 are arranged in a row at both sides of the injector 100. These clamps 105 are tightened to a screw hole of cylinder head 131 through a washer 107 by screw up the bolt 106. These clamps 105 have a problem that they become too wide in a width direction of the injector 100 that the design of the cylinder head 131 must be changed. Further, since it is fitted by bolt 106, high cost is required at an assembly line by increasing number of steps.

Flange part 100B of the injector 100 is fixed to the cylinder head 131 through cupper gasket 121 disposed at the back face of the flange part 100B. A contacting face, which is a backside of the flange 100B, is sealed with the cupper gasket 121. This cupper gasket 121 is composed of a metal gasket which resist heat from inner side of the cylinder head 131 that the gasket 121 lacks rubber-state elastic force and seal ability.

At the bottom of the injector 100, support plate 122 of flat spring-state is disposed. This sheet 122 should also be heat-resistance and be composed of metal, so that it has weak point of lacking the sealing ability.

This support plate 122 elastically supports the injector 100 and prevents the injector 100 from damage by the pressure of clamp 105. Accordingly, in order to effect the sealing ability of the copper gasket 121, size accuracy of the injector 100 and the fitting hole of the cylinder head 131 must advance. This size processing accuracy increases the processing cost.

This injector 100 receives delivery fuel pressure pressed and sent from the delivery pipe 130 downwardly as shown with an arrow “A” through O-ring 120. Further, pressure of the delivery fuel pressed and sent from the delivery pipe 130 is 5 to 25 MPa.

On the other hand, this injector 100 receives gas pressure from inner side of the cylinder head 131 by a direction shown with an arrow “B”. This gas pressure is 5 to 20 MPa.

Injector 100 fitted as above is fixed to cylinder head 131 through copper gasket 121 of clamp 105. Accordingly, a palce where the clamp 105 is set is required and that the design of cylinder head 131 must be changed. Further, clamp 105 is set by bolt 106, accordingly, manufacturing process increases and the cost on an assembly line increases.

Further, since the injector 100 can be fitted with clamp 105, main part 100F and flange part 100B must be set at a lower part of a branch tube 100A and that the size of the injector 100 increases. Further, when the size of injector 100 increases, the distance between the delivery pipe 130 and the cylinder head 131 becomes long and that the fitting structure becomes complicated.

### SUMMARY OF THE INVENTION

The present invention is done to overcome the above-mentioned problems. The object of the present invention is to provide a clamp device wherein; even when the fitting part of a branch product is structurally narrow, the clamp device can be easily fitted, the branch product can be small-sized, and the branch product can be easily fitted.

Further, the other object of the present invention is to provide a clamp device which can absorb a size error between manufacturing size of the branch product and fitting size of the fitting part, and by absorbing the size error, processing accuracy is decreased to lower the processing cost.

Further, the other object of the invention is to provide a clamp device wherein the fitted branch product can be elastically held not to be damaged by a vibration or so of the fitting part, and even when the fitting part vibrates, the injector does not rotate around a center axis and prevents the bad condition.

The present invention is done to overcome the above-mentioned object and technical solving methods of the invention is composed as follows.

Namely, the clamp device of the invention is

a clamp device arranged between two device parts wherein a first end part is connected to a first device part and a second end part is connected to a second device part, and holding a branch product wherein a branch part is formed at a main part of the branch product;

comprising a clamp body in which main part of the branch product is inserted and formed with notch part where the branch part can pass through in axial direction, wherein:

a first end part of the clamp body contacts said first device part and a second end part of the clamp body contacts a fitting part of the branch product,

and the clamp body has an elastic force toward axial direction pressing the branch product toward the second device part against the first device part.

The clamp device as in the present invention, the branch part go through the notch part that the clamp device can fit into the main part of the branch product without the branch product interfering the clamp device. Accordingly, in the clamp device, the branch product can be fixed to the second device part by utilizing main part having the branch part. Therefore, the length of the branch product can be shortened and it has a merit that the fitting part is not restricted to be placed.

Further, even when distance between the second device part and the first device part varies by processing accuracy, the clamp device elastically displaced in the axial direction and fix the branch product. Therefore, regardless of unevenness of the processing accuracy of the branch product, the branch product can be fixed.

Further, even when vibration occurs at the second device part, the branch product is prevented from damaging by the vibration since the branch product is elastically fixed to the second device body by the clamp device. Further, due to the notch part set at the clamp device, the clamp device is easily equipped to the branch product, and the branch product is easily fitted between the second device part and the first device part.

According to the invention, an engagement part is formed at the first end part of the clamp body, and said engagement part is engaged with the first device part.

In this case, notch part of the clamp device engage with the branch part of the branch product and the engagement part engages with the first device part. Accordingly, when the branch product starts to rotate around central axis, the branch product is prevented from rotating. Particularly, due to an elasticity of the clamp device, even when each part of the device receives vibrational forces, it is prevented to damage from said part. Further, the clamp device fixes branch product by its elasticity, the structure of the device becomes simple.

Preferably, the notch part extends through the whole length of the clamp body along the axial direction.

In this case, since the notch part extends through the whole length of the clamp body along the axial direction, the notch part makes the clamp device extremely easy to insert to the branch product. Further, even when size of main part of the branch product is somewhat large, the clamp device provided with the notch part varies in size that it is easy to fit to the branch product.

Further, the notch part may be U-shaped in the axial direction.

In this case, since the notch part is U-shaped in axial direction, the notch part is not formed at the first end part or the second end part of the clamp device, and both end parts are still annular formed. Therefore, connection force between the fitting part of main part or so of injector and the clamp device can be firm. Moreover, by the annular-formed first end part of the clamp device, the branch product and the first device part are firmly attached and connected, and the connecting face can be sealed.

### BRIEF DESCRIPTION OF THE DRAWINGS

FIG. 1 is a side view of a clamp device of the first embodiment of the invention fitted to a branch product.

FIG. 2A is a sectional view of the clamp device as in along the line IIA-IIA shown in FIG. 1.

FIG. 2B is a perspective view of a main part showing engagement state of a delivery pipe and the clamp device as shown in FIG. 1.

FIG. 3 is a side view of a clamp device of the second embodiment of the invention.

FIG. 4 is a planner view of the clamp device of FIG. 3.

FIG. 5 is a side view of a clamp device of the third embodiment of the invention.

FIG. 6 is a planner view of the clamp device of FIG. 5.

FIG. 7 is a side view of a clamp device of the fourth embodiment of the invention.

FIG. 8 is a perspective view of the clamp device of the fifth embodiment of the invention.

FIG. 9A is a perspective view of a clamp device of the sixth embodiment of the invention.

FIG. 9B is a perspective view of a clamp device of the seventh embodiment of the invention.

FIG. 10 is a graph showing permissible range of load and length of the clamp device of the invention.

FIG. 11 is a side view of the injector fitting a conventional clamp device.

### DESCRIPTION OF THE PREFERRED EMBODIMENTS

Following is a brief description of the preferred embodiments of a clamp device according to the present invention given with reference to the attached drawings. Each figures described below is based on the designed figures accurate in size founded on experimented data.

In FIG. 1, “1” shows the clamp device in a flange part 100B. Clamp device 1 is in a cylindrical form. Notch part 1C1 is formed at a part of the cylindrical formed side face and notch edges 1C, 1C are formed at both sides of the notch part 1C1. The size between the notch edges 1C, 1C, namely width of the notch part 1C1 is approximately the same with the diameter of branch part 10B of the branch product 10 and the branch part 10B fit into the notch part 1C1. Namely, the size between these notch edges 1C, 1C is made to be a distance which the branch part 10B can fit into.

Further, a first end part 1D and a second end part 1E are formed at both end parts of clamp device 1 in axial direction. This first end part 1D is pressed onto an end part of delivery pipe 30 by an elastic force in axial direction of clamp device 1.

Further, the second end part 1E closely contacts a step part (fitting part) of body 10C at injector (a branch product) 10. Namely, the second end part 1E engages with a step part of body 10C and the injector 10 is pressed to a lower part of FIG. 1 by an elastic force in axial direction of the clamp device 1.

Clamp device 1 has a convex formed engagement part 1A at the first end part 1D projecting in axial direction to engage with a concave part 32 of delivery pipe 30. And the clamp device 1 is connected to the delivery pipe 30 by the engagement part 1A and composed not to rotate.

Notch part 1C1 of clamp device 1 engages with branch part 10B of injector 10, 10 accordingly, the injector 10 is prevented from rotating around central axis by the clamp device 1. As a result, even cylinder head 20 i.e. the second device part vibrates, the injector 10 is prevented from rotating only by equipping the clamp device 1. And the branch product 10 is able to be connected to the cylinder head 20 and the delivery pipe 30.

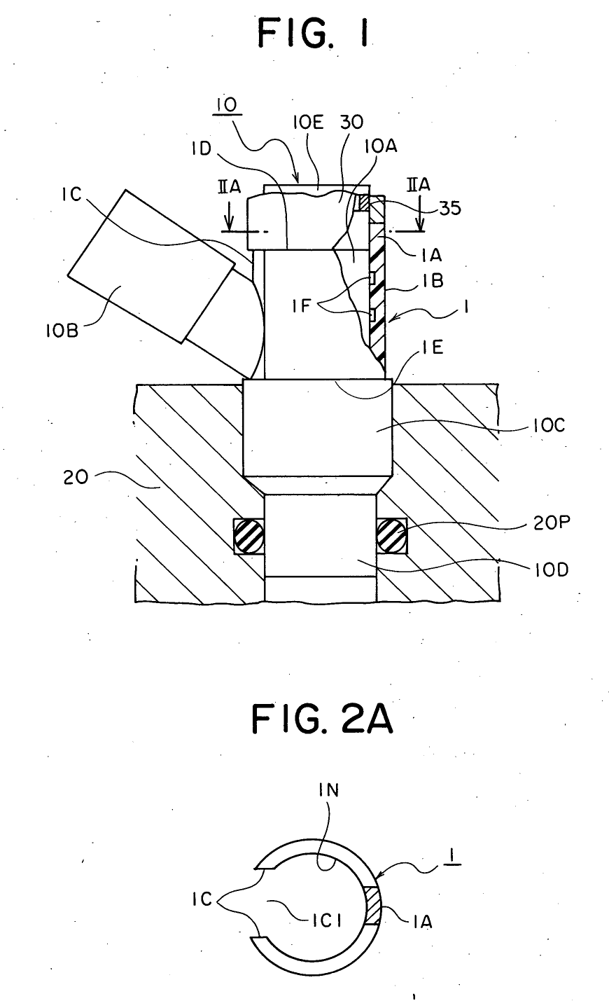

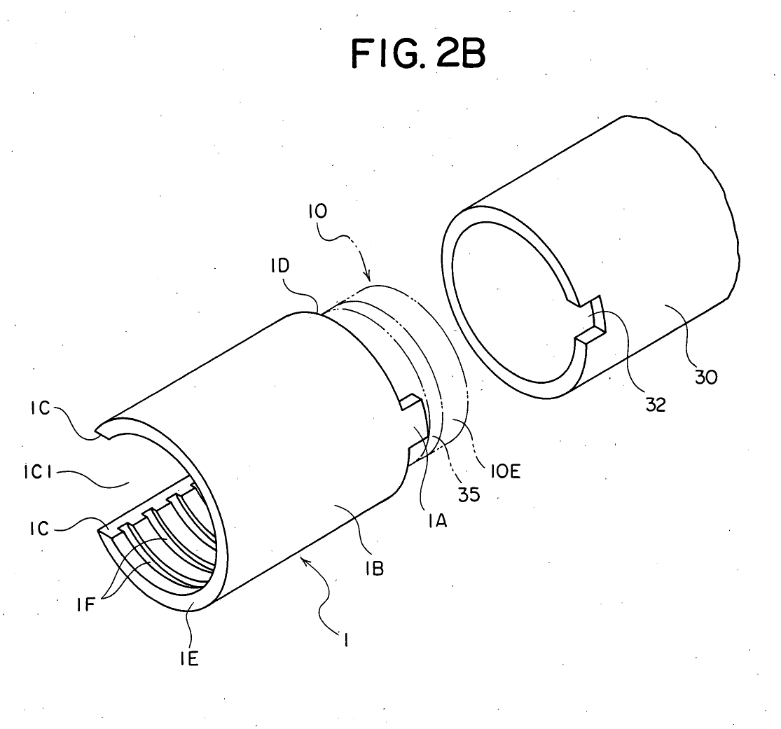

This clamp device 1, as shown in FIG. 2A and FIG. 2B, its section is C-shaped, and has cylindrical clamp body 1B as a whole. A plural number of annular recesses 1F are arranged in a row along axial direction on internal circumference surface 1N of clamp device 1 and give the clamp body 1B an elastic force in axial direction. Further, the clamp device 1 is formed with notch part 1C1 that the device also has an elastic force in radial direction.

This clamp device 1 can be comprising an adiathermic rubber or resin, but preferably comprising superelastic alloys to stand intense heat. The injector 10 is pressed and fixed to cylinder head 20 by elastic force of this clamp body 1B and connected to delivery pipe 30.

The injector 10 fixed by the clamp device 1 is formed with body 10C which fit to a fitting hole of cylinder head 20 through O-ring 20P. Solenoid coil or so are built in the body 10C. Injection pipe 10D wherein needle bulb or so is installed, is set at a tip of the body 10C. Further, the main part 10A at upper part of the body 10C are formed. And the branch part 10B forked into two from the main part 10A are formed. Electric connector connected to the solenoid coil is set at the branch part 10B.

Further, fuel connector 10E fit into the delivery pipe 30 at the upper part of main body 10A. The fuel connector 10E fit into internal circumference surface of delivery pipe 30 through O-ring 35.

Cylinder head 20 is the second device part and is a head cover of combustion chamber of internal combustion engine. Further, delivery pipe 30 is the first device part and is set to cylinder head 20 and supply fuel to the combustion chamber.

There is a technical problem that the distance between the delivery pipe 30 and the cylinder head 20 should be structurally small. Further, cost reduce is required by dropping processing accuracy of the injector due to cost reduce of internal combustion engine.

Injector 10 composed as above is connected as following. Body 10C is fitted to cylinder head 20 and fuel connector 10E is fitted into delivery pipe 30. Here, O-ring 20P seals between the injection pipe 10D of injector 10 and the cylinder head 20. Further, O-ring 35 seals between the fuel connector 10E and the injector 10. A manufacturing error of distance between the cylinder head 20 and the delivery pipe 30 will be absorbed by vertical movement of fuel connector 10E, which fit into the delivery pipe 30 and seal.

The second end part 1E of this clamp device 1 is pressed onto a top face of step part (fitting part) of injector 10 and the first end part 1D is pressed onto an end face of delivery pipe 30. And a manufacturing error between the cylinder head 20 and the delivery pipe 30 is absorbed by the clamp device 1 with an elastic force elastically changes in axial direction.

Further, an engagement part 1A set at the first end part 1D of the clamp device 1 is engaged and connected to a concave part 32 of the end part of delivery pipe 30. The engagement part 1A and the concave part 32 are connected as one and locked not to rotate. Further, the clamp device 1 is fitted into main part 10A of injector 10 and the notch edges 1C, 1C are in contact with the branch part 10B and fix the injector 10 not to rotate.

Cylinder head 20 is fixed to a body frame or so which is omitted in Figures. The delivery pipe 30 is also fixed to the body frame or so which is omitted in Figures. The clamp device 1, by its elastic force in axial direction, presses the step part of the body 10C of injector 10 toward cylinder head 20. Further, the clamp device 1, by its elastic force in axial direction, presses an end part of delivery pipe 30 to leave from cylinder head 20.

As a result, the injector 10 is elastically held between delivery pipe 30 and cylinder head 20, wherein the fitting parts of the pipe 30 and the cylinder head 20 are fixed, by the clamp device 1 under the condition that the injector is somewhat movable in axial direction. Moreover, the injector 10 is prohibited from rotating in relative to the delivery pipe 30 by the clamp device 1.

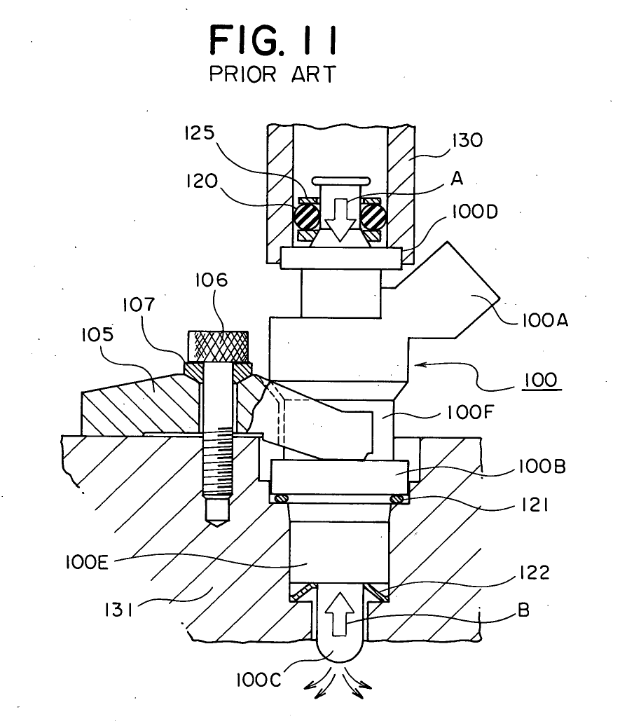

As mentioned above, clamp device 1 fixes injector 10 through main part 10A providing the branch part 10B. Accordingly, different from the conventional clamp device, a special part (e.g. main part 100F and flange part 100E as shown in FIG. 11) where the clamp device 1 is fitted is not required. Particularly, a special part where the clamp device 1 is fitted is not required that the length of the injector 10 can be shortened. Consequently, the injector 10 can be small-sized and makes it easy to equip the clamp device 1. Moreover, even there exist a manufacturing error of the injector 10, the clamp device 1 having elasticity can easily absorb said error.

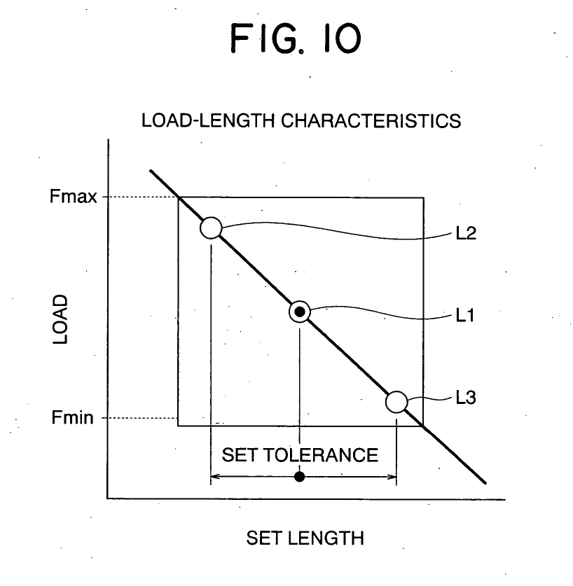

FIG. 10 shows a relation between set tolerance of the injector 10 and load effect to the clamp device in axial direction when setting the injector 10 between delivery pipe 30 and the cylinder head 20 by this clamp device 1. Clamp device 1 is required to press the delivery pipe 30 and the injector 1 with prescribed elastic force in axial direction in order for the delivery pipe 30 and the injector 1 are mutually separated. When the minimum value of the elastic force in axial direction is Fmin, and the maximum value of the same is Fmax, length of the clamp device 1 in axial direction is required to be set in order for said force to be within said range.

Namely, when length in axial direction of the clamp device 1 is compressed to the appropriate setting length L1, and fitting the clamp device 1 between the delivery pipe 30 and the injector 1, clamp device 1 is designed in order for the length of the clamp device 1 is between L2 and L3 of FIG. 10, even the distance of manufacturing error between the cylinder head 20 and the delivery pipe 30 varies. Length L2 of the clamp device 1 is the length wherein the clamp device 1 is more compressed in axial direction than an ideal length L1 and act an elastic force close to Fmax; an elastic force in axial direction in permissible range. Further, length L3 of the clamp device 1 is the length wherein the clamp device 1 extends in axial direction longer than an ideal length L1 and act an elastic force close to Fmin.

By setting the size relations as above, even when size distance between the cylinder head 20 and the delivery pipe 30 changes due to manufacturing error, the injector 10 can be elastically held between the cylinder head 20 and the delivery pipe 30. Further, even cylinder head 20 vibrates, elastic force of the clamp device 1 prevents injector 10 from damage due to the vibration.

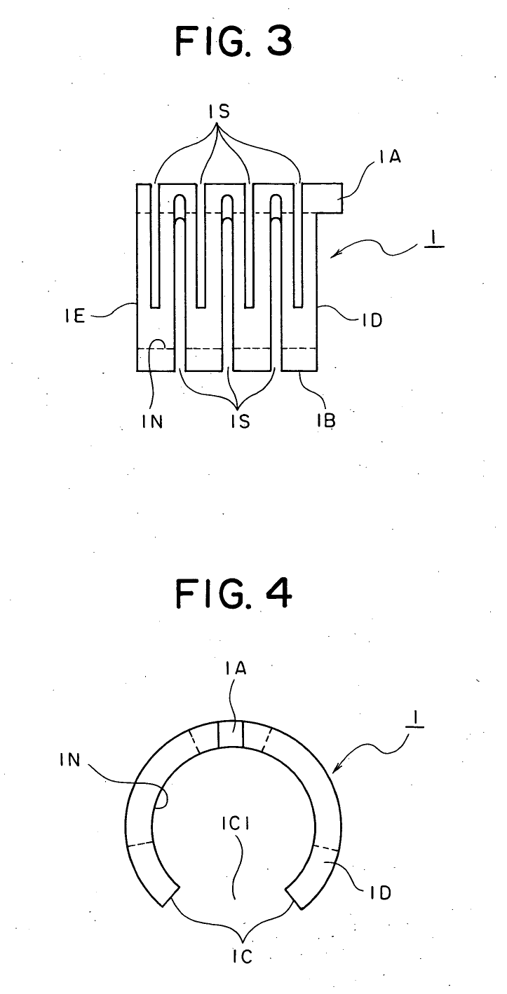

FIG. 3 and FUG. 4 are a clamp device 1 of the second embodiment according to the invention. FIG. 4 and FIG. 3 are a plane views.

As shown in FIG. 3, slits is extending in radial direction are alternately formed along axial direction to metal made and annular formed clamp body 1B and give spring force. Further, internal circumference surface 1N is set at clamp body 1B. Inside diameter and thickness of clamp body 1B are determined to provide designed elastic force. The second end part 1E and the first end part 1D are formed at both ends of the clamp body 1B. An engagement part 1A is formed at the end part 1D. Notch edges 1C, 1C that extend through the along axial direction are formed at side faces of the clamp body 1B.

This clamp device 1 are manufactured from materials such as stainless steel, spring steel, superelastic alloys or so.

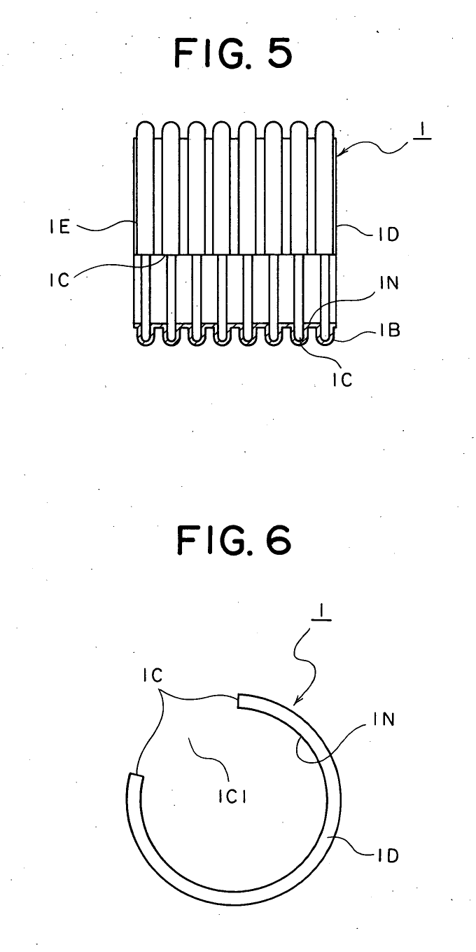

FIG. 5 and FUG. 6 are clamp device 1 of the third embodiment according to the invention. FIG. 5 is a side view of the clamp device 1 wherein the device comprises metal made bellows. Further, FIG. 6 is a plane view of FIG. 5.

FIG. 5 differs from FIG. 3 in the respect that spring force is provided to the clamp device by forming bellows at the body part instead of forming slits 1S at body part of clamp device.

Parts in FIG. 5 and FIG. 6 in common with the same in FIG. 3 and FIG. 4 are given the same numeral numbers as given in FIG. 3 and FIG. 4, and their brief descriptions are abbreviated.

Although an engagement part 1A is abbreviated in the clamp device 1 of FIG. 5, the engagement part 1A may be formed as shown in FIG. 3 and engage with concave part 32 of the delivery pipe 30 and connected to the pipe 30. This clamp device 1 manufactured by materials such as stainless steel, spring steel, superelastic alloys or so.

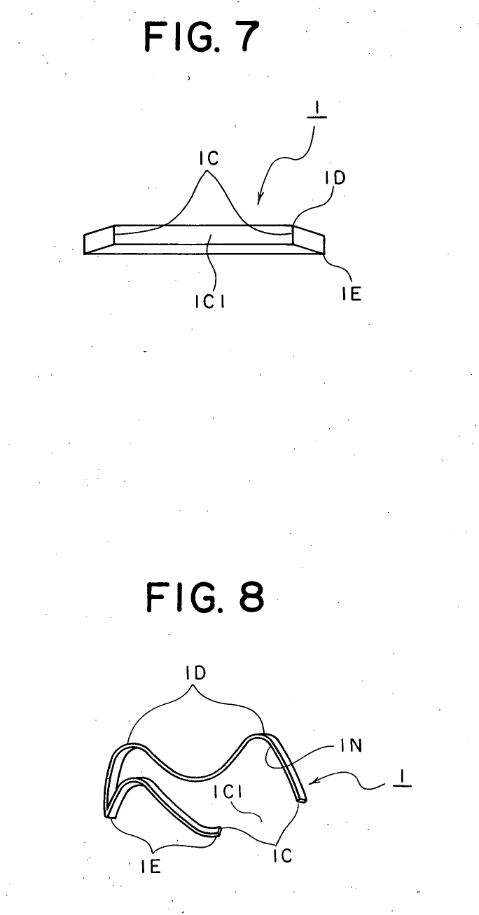

FIG. 7 is a clamp device 1 of the fourth embodiment according to the invention. This clamp device 1 is formed as countersunk spring. Notch edges 1C, 1C are formed at a side face and notch part 1C1, which extends through along the axial direction, are formed.

The injector 10 is secured by disposing the clamp device 1 between a step part (fitting part) formed at the upper part of the branch part 10B in injector 10 and an end face of the delivery pipe 30.

The other compositions of the clamp device 1 as in FIG. 7 are the same as in FIG. 3 shown with the numeral numbers.

Clamp device 1 according to the present embodiment is appropriate when branch part 10B is small or when the part 10B does not exist. Consequently, it becomes possible to minimize the injector 10. This clamp device 1 is manufactured by the materials such as spring steel, superelastic alloys or so.

FIG. 8 is a clamp device 1 of the fifth embodiment according to the present invention. This clamp device 1 is a clip corrugated along circumference direction. And notch edges 1C, 1C are formed at a side face and notch part 1C1, which extends along the axial direction, are formed.

The injector 10 is secured by disposing the clamp device 1 between step part set at the upper part 10B of the branch part in injector 10 and the end face of the delivery pipe 30. Further, it is appropriate when branch part 10B is small or when the part 10B does not exist. Consequently, it becomes possible to minimize the injector 10. The other compositions of the clamp device 1 as in FIG. 8 are the same with the compositions shown with the reference numbers as in FIG. 3. Therefore, parts in common with the same in FIG. 3 are given the same numeral numbers as given in FIG. 3, and their brief descriptions are abbreviated.

The clamp device 1 is manufactured by materials such as spring steel, superelastic alloys or so.

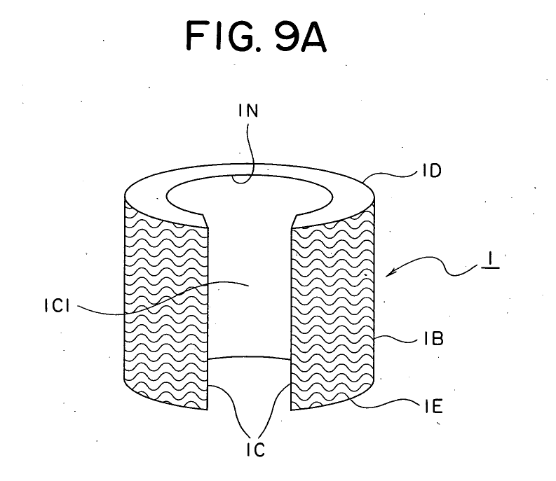

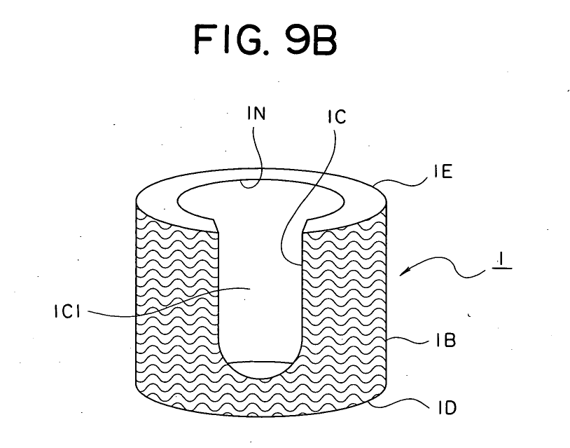

FIG. 9A is a clamp device 1 of the sixth embodiment according to the present invention. This clamp device 1 is a cylindrically shaped form which is made by rolling up a wire netting sheet. And by forming notch edges 1C, 1C, notch part 1C1 are formed which extends along the axial direction.

By forming the notch part 1C1, clamp device 1 becomes particularly easy to be equipped at the injector 10.

Further, in clamp device 1, other than metals, heat-resistant synthetic resins or so can be used as a wire rod. This clamp device 1 softly compresses wire rod and that the device 1 has elastic force.

The other compositions of FIG. 9A are the same with the compositions shown with the reference numbers as in FIG. 3. Therefore, parts in common with the same in FIG. 3 are given the same numeral numbers as given in FIG. 3, and their brief descriptions are abbreviated.

In above clamp device 1, notch edge 1C is formed to extend through the whole length of the clamp body 1B along the axial direction, however, the notch edge 1C may be U-shaped at side face of the cylindrical form 1B. For instance, notch edge 1C can be U-shaped from the second end part 1E. Accordingly, the first end part 1D and an end face of delivery pipe 30 are attached and firms the connection force between them and said connecting face can be sealed.

According to clamp device 1 of the invention, the clamp device is fixed through main part formed at a branch part of the clamp device that a special part where the clamp device is fitted is not required. Therefore, the clamp device 1 of the invention is effective in shortening the length of the branch product.

Further, the clamp device makes it easy to be equipped to the branch product. Further, an elasticity of the clamp device can easily absorb processing size error of the branch product. Due to these, manufacturing costs of the clamp device and the branch product can be reduced.

Moreover, elasticity of the clamp device can correspond to vibration or so of the cylinder head 20 and that it effectively prevents the branch product to be damaged.

The invention is not limited to the above-mentioned embodiments and can be varied in various ways within the scope of the invention. For instance, in the above-mentioned embodiments, the first end part 1D of the clamp device 1 and an end part of delivery pipe 30 are engaged merely by mutual contact. Also, the second end part 1E of the clamp device 1 and a step part of body 10C of injector 10 are engaged merely by mutual contact. The present invention is not limited to the above-mentioned composition. One end part or both end parts can be fixed to the other side part by welding them or any other method to completely engage the parts.

What is claimed is:

1. A clamp device arranged between two device parts wherein a first end part is connected to a first device part and a second end part is connected to a second device part, and holding a branch product wherein a branch part is formed at a main part of the branch product;
comprising a clamp body in which main part of the branch product is inserted and formed with notch part where the branch part can pass through in axial direction, wherein:
a first end part of the clamp body contacts said first device part and a second end part of the clamp body contacts a fitting part of the branch product,
and the clamp body has an elastic force toward axial direction pressing the branch product toward the second device part against the first device part.

2. The clamp device as set forth in claim 1, wherein an engagement part is formed at the first end part of the clamp body, and said engagement part is engaged with the first device part.

3. The clamp device as set forth in claim 1, wherein the notch part extends through the whole length of the clamp body along the axial direction.

4. The clamp device as set forth in claim 2, wherein the notch part extends through the whole length of the clamp body along the axial direction.

5. The clamp device as set forth in claim 1, wherein the notch part is U-shaped in the axial direction.

6. The clamp device as set forth in claim 2, wherein the notch part is U-shaped in the axial direction.

7. The clamp device as set forth in claim 1, wherein the branch product is an injector having the branch part, the first device part is a delivery pipe, and the second device part is a cylinder head.

8. The clamp device as set forth in claim 7, wherein
the injector has a main body provided with a step part and the second end part of the clamp device is pressed onto a top face of the step part,
the first end part of the clamp device is pressed onto an end part of the delivery pipe, and
an elastic force of the clamp device along axial direction press the injector toward a fitting hole formed at the cylinder head against the end part of the delivery pipe.

9. The clamp device as set forth in claim 8, wherein the notch part is formed to avoid the branch part of the injector.

10. The clamp device as set forth in claim 1, wherein
the clamp body is a cylindrical form and annular recesses are formed on an internal circumference surface of the clamp body to provide elastic force to the clamp body.

11. The clamp device as set forth in claim 1, wherein
the clamp body is a cylindrical form and slits are alternately formed in radial direction along axial direction at the cylindrical formed clamp body to give elastic force to the clamp body.

12. The clamp device as set forth in claim 1, wherein
the clamp body is a cylindrical form and the cylindrical formed clamp body comprises bellows to give elastic force to the clamp body.

13. The clamp device as set forth in claim 1, wherein
the clamp body is a cylindrically shaped form which is made by rolling up a wire netting sheet to give elastic force to the clamp body.
